(19) United States
(12) Patent Application Publication
(10) Pub. No.: US 2020/0034791 A1
(43) Pub. Date: Jan. 30, 2020

(54) DYNAMIC LOGISTICS MANAGEMENT SYSTEM AND METHOD

(71) Applicant: Goldtek Technology Co., Ltd., New Taipei City (TW)

(72) Inventors: YEN-CHING LEE, New Taipei (TW); YU-CHANG SONG, New Taipei (TW); PO-SHENG WANG, New Taipei (TW)

(21) Appl. No.: 16/455,777

(22) Filed: Jun. 28, 2019

(30) Foreign Application Priority Data
Jul. 27, 2018 (TW) 107126250

(51) Int. Cl. G06Q 10/08; G06Q 10/06; G07C 5/00

(52) U.S. Cl. CPC G06Q 10/08355; G07C 5/008; G06Q 10/06315

(57) ABSTRACT

A dynamic logistics management method is disclosed. The method comprises at least processes that include: communicating to an onboard terminal of a vehicle from a mission planning server a first mission route associated with a first task; receiving a status message from the onboard terminal upon completion of the first task, wherein the status message comprises position information of the onboard terminal; checking, applicability of a mission candidate associated with a second task; if applicable, performing by the mission planning server a first phase determination for applicable mission candidate based on a first threshold; performing by the mission planning server a second phase determination based on a second threshold different from the first threshold; and generating by the mission planning server a second mission route associated with the second task.

### CROSS-REFERENCE TO RELATED APPLICATIONS

This application claims priority to Taiwanese Invention Patent Application No. 107126250-filed on Jul. 27, 2018, the contents of which are incorporated by reference herein.

### FIELD

The present disclosure generally relates to system and method for dispatching and managing mobile resources, and more particularly relates to systems and methods for dynamically routing, scheduling, and dispatching mobile resources to achieve more efficient utilization of mobile assets.

### BACKGROUND

Managing mobile assets in logistics applications has traditionally been a demanding task. When preparing delivery manifests, conventional dispatchers are required to analyze the subject to be transported, the associated delivery locations, and the available vehicle assets to create the delivery routes for the vehicles. Time and money may be wasted when optimized delivery routes are not chosen.

Therefore, there remains a need to provide a more efficient logistics system and method to reduce delivery cost and provide a better delivery service.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an exemplary operating environment of a logistics management system in accordance with some embodiments of the instant disclosure.

FIG. 2 illustrates an component block diagram of a logistics management system in accordance with some embodiments of the instant disclosure.

FIG. 3 shows a flow diagram of an illustrative method implementing by a logistics management system in accordance with some embodiments of the instant disclosure.

FIG. 4 is a block diagram showing an operation flow of a logistics management method in accordance with some embodiments of the instant disclosure.

It is to be noted, however, that the appended drawings illustrate only exemplary embodiments of this disclosure and are therefore not to be considered limiting of its scope, for the disclosure may admit to other equally effective embodiments.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

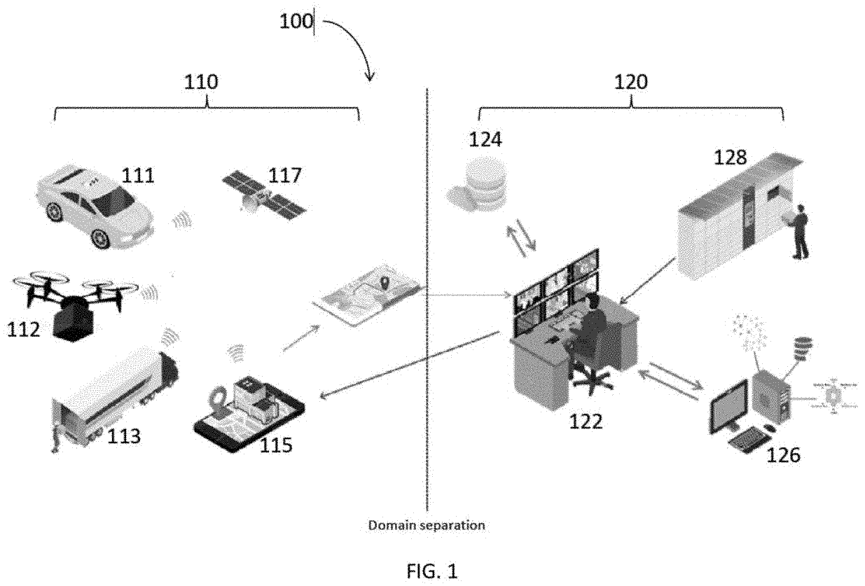

The description will be made as to the exemplary embodiments in conjunction with the accompanying drawings in FIG. 1 to 4. Reference will be made to the drawing figures to describe the present disclosure in detail, wherein depicted elements are not necessarily shown to scale and wherein like or similar elements are designated by same or similar reference numeral through the several views and same or similar terminology.

FIG. 1 illustrates an exemplary operating environment 100 of a logistics management system in accordance with some embodiments of the instant disclosure. Among other features, the exemplary logistics management system 120 can perform dynamic mission planning based upon distance, time, cost, vehicle conditions, and other considerations.

The operating environment 100 generally comprises components in a field asset domain 110 (as illustrated on the left side of the domain separator) and components in a system asset domain 120 (as shown on the right side of the separator). The example logistics management system (e.g., the components in the system asset domain) 120 includes a communication component 122, a database component 124, a processing component 126, and a logistics storage component 128.

The field asset domain 110 may comprise a wide variety of mobile assets, such as passenger transport vehicle 101, automated unmanned vehicle 103, shipping transport vehicle 105, and an onboard terminal 107. Among other features, each of the mobile assets are provided with positioning capability, e.g., by incorporating global positioning satellite (GPS) technology through data received from satellite 117. To ensure flexible implementation, the positioning capability for the mobile assets may be provided by an integrally built-in component, or a subsequently added-on unit adapted at a later time. The mobile assets may be motorized or non-motorized carrier vehicles configured to traverse through land, air, or water for performing logistics tasks such as personnel transportation and material delivery.

The onboard terminal 107 may include one or more hardware components or software applications for performing one or more functions described herein. For instance, the onboard terminal 107 may include one or more computer processors as well as a variety of sensors/receivers such as cell-phone transceiver, GPS receiver, accelerometer, and gyroscope. The onboard terminal 107 may be configured to capture, recorder, and analyze information or data regarding the position, velocity, acceleration, and orientation of the device (or the vehicle on which it boards), e.g., by processing such data information to form one or more qualitative or quantitative metrics of the movement status. For manned mobile assets, the onboard positioning device (e.g., onboard terminal 107) may be configured to generate a visual representation of routing information for the vehicle operator. The onboard terminal in a mobile asset may provide precise real-time location and time information to the logistics management system, thus enabling dynamic optimization of logistics tasks. For instance, the onboard terminal may send a status message to the logistics management system upon the vehicle's completion of a task. The logistics management system may then utilize the information in the status message to dynamically generate optimized follow-up mission(s) for that particular vehicle, thereby maximizing available asset capacity in the field while minimizing operational cost.

The communication component 122 can facilitate communication with the mobile assets (e.g., 111-115) over suitable communication network, which may include wired and wireless mediums. The communication component 122 may receive data from the mobile assets for information storage and processing, and transmit data to the mobile assets for mission instruction and routing update. The communication component 112 may be implemented in a centralized communication station (e.g., a dispatch center), as shown in the illustrated embodiment. The exemplary dispatch center may act as a central communication hub for facilitating coordination between or within assets in the field asset domain 110 and the system asset domain 120, and may include both human operated elements and unmanned automated elements. Nevertheless, in some embodiments, the communication component 112 may be implemented as an electronic module in a automated system in either a centralized or a clustered configuration.

The database component 124 can include one or more storage devices configured to store task related information. For example, the database component 124 may include a mission information database that is capable of storing customer information, delivery information, order preference and requirement, etc., which may be indicative of the pickup/drop-off locations, time of delivery, and preferred means of transportation for a logistics task. The database component 124 may be implemented as an on-site storage device in the premises of a logistics service operator, or an de-centralized off-site storage device accessible to the logistics service operator. For example, the database component 124 may be implemented in the form of a cloud storage media accessible to other components of the logistics management system through the communication component 124 via a network. In some embodiments, data associated with a newly received task may be inputted or updated in the database component 124 from other components of the logistics management system, e.g., from a online customer interface. The database component 124 may dynamically provide task-related information to the logistics management system, so as to enable dynamic mission planning and optimization for pending logistics tasks.

The processing component 126 may include hardware and software modules that can process information received from the mobile assets 111-115 and the database component 124 and generate mission plans for associated logistics tasks. By way of example, the processing component 126 can generate one or more optimized mission routing plans associated with a delivery task. The mission route planning/optimization may be based on variety of dynamic parameters, such as information received from the mobile assets, e.g., vehicle geological status information (such as location and time) and vehicle operational information (such as vehicle capacity information and fuel load condition, etc), as well as inputs from other components of the logistics system (e.g., new task information). For instance, the processing component 126 can determine one or more feasible candidate routes based on a mobile asset's reported location to a unplanned/newly received task. The feasible route(s) is then evaluated by the processing component 126 using algorithms based on one or more criteria, factors, or variables (e.g., route deviation and incurred costs) to determine whether to pass the associated mission routing plan for execution. The processing component 126 may dynamically perform mission planning/generation for the for available mobile assets in the field, thereby maximizing utilization of asset capacity while minimizing operational cost. The processing component 126 may comprises computing hardware and software modules that are implemented either in centralized or clustered configurations.

The logistics storage component 128 is arranged to store items pending shipment. In material delivery context, the logistics component 128 may be a facility where parcels, packages, boxes, and containers are collected, such as a storage station. In personnel transportation context, the logistics storage component 128 may be locations where passengers aggregate. The logistics storage component 128 may be a manned or unmanned facility where the stored items are securely kept and documented. The logistic storage component 128 may include electronic system(s) that generates manifest indicative of the stored items and the associated logistics tasks thereof. In some embodiments, the logistics storage component 128 includes system(s) that is capable of communicating with other components of the logistics management system 120 and dynamically updating (e.g., to the database component 124) information regarding the status of the stored items (and their associated logistics tasks).

It is noted that the functional components of the system 120 may be implemented in automated electronic systems, which may be either in a centralized or a clustered arrangement, and may be allocated in either a same or different physical locations. Moreover, specific designation of the domain component need not be identical to the illustrated example. For instance, in some embodiments, the storage 125 may be designated as an component of the field asset domain, and may be situated at a location that is outside the premises of a logistics management center (e.g., a dispatch center).

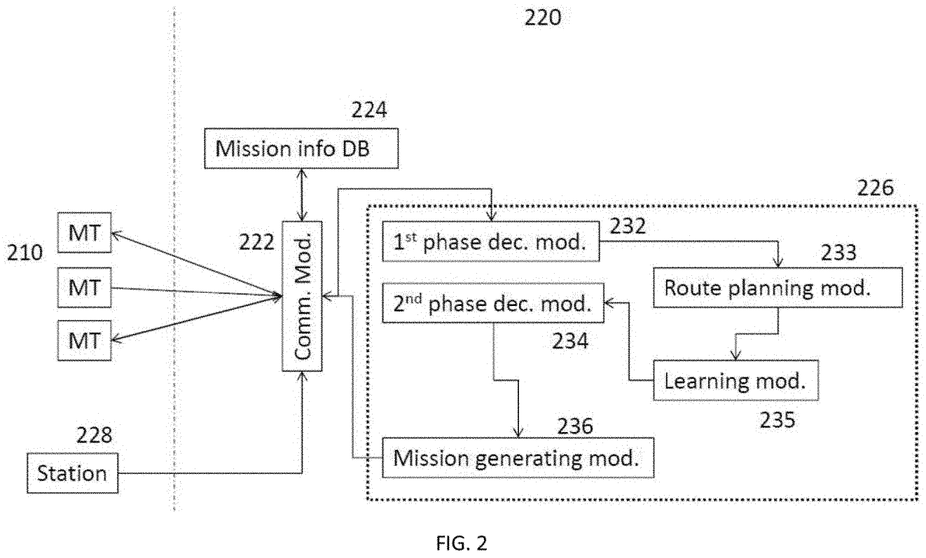

FIG. 2 illustrates an exemplary component block diagram of a logistics management system 220 in accordance with embodiments of the instant disclosure. The illustrated logistics management system 220 comprises a communication module 222, a mission information database 224, and a processing unit 226. The logistics management system 220 is capable of interacting with the mobile terminal 210 of a variety of logistics carrier vehicles, e.g., to receive real-time location and time information from the mobile asset(s) in the field that are performing logistics tasks. For instance, the mobile terminal 210 of a mobile asset may send a status message containing one or more vehicle status parameter to the logistics management system 220 upon the vehicle's completion of a logistics task. In response, the logistics management system 220 can dynamically generate optimized mission plan(s) for the particular vehicle to maximize available asset capacity while minimize operational cost.

The communication module 222 is an electronic module containing necessary hardware, software, or firmware components to perform communication functions with the mobile terminal(s) 210 over suitable communication network(s). The communication module 222 can receive data from the mobile terminals 210 for information storage and processing, as well as transmit data to the mobile assets for mission instruction and routing update. In some embodiments, the communication module 222 may be implemented in a centralized communication station (e.g., a dispatch center), or in a de-centralized redundant fashion.

The mission information database 224 is configured to store task related information, and may include one or more storage devices. For example, the mission information database may comprise electronic storage device(s) capable of storing task-related data such as customer information, delivery information, order preference and requirement information, which may be indicative of the pickup/drop-off locations, time of delivery, and preferred means of transportation for a logistics task. The mission information database 224 may be implemented as an on-site storage device in the premises of a logistics service operator, or as an de-centralized off-site storage device accessible to other components of the logistics management system 220. For example, the mission information database 224 may be implemented in the form of a cloud storage media accessible to other components of the logistics management system through the communication component 222 via a network.

In some embodiments, data associated with a newly received task may be inputted or updated in the mission information database 224 from other components of the logistics management system. For instance, to a mission routing information associated with a particular logistics task (e.g., optimized routing plan) generated by a mission planning module 233 of the processing unit 226 (will be discussed in further detail below) can be forwarded to and stored in the mission information database 224 for future retrieval. The mission information database 224 may dynamically provide task-related information to the logistics management system (e.g., when a new pending task is available/ applicable), so as to enable dynamic mission planning and optimization for mobile assets in the field.

The processing unit 226 may include one or more hardware, software, or firmware modules, such as servers. These servers can be arranged in a centralized configuration or in a separated cluster arrangement. The processing unit 226 can process information received through the communication module 222, and accordingly perform mission planning for associated logistics tasks. In the illustrated embodiment, the exemplary processing unit 226 includes a first phase decision module 232, a route planning module 233, a second phase decision module 234, a learning module 235, and mission generation module 236.

The first phase decision module 232 is data communicatively coupled to information sources such as the mission information database 224 and the mobile terminal(s) 210. The first phase decision module 232 is configured to perform a first phase determination based on a first parameters extracted from the received status message. In the illustrated embodiment, the first phase decision module 232 performs the first phase determination based on a geographical parameter received from a mobile terminal, e.g., the position information extracted from raw GPS pings. The first phase decision based on the dynamic receipt of a mobile asset's location status may help to determine whether a subsequently received (often unplanned/unscheduled) task can be economically fitted into that particular mobile asset's mission plan without incurring excessive extra cost. Accordingly, the first phase determination process helps to more efficiently utilize mobile assets that are already deployed in the field.

For instance, in some embodiments, the received position information represents the location of the mobile terminal 210 (and the associated mobile asset) upon completion of a first task, which is associated with a first mission route that was previously planned (and at least partially traveled) by the mobile asset. A mission route may include a location of initial departure (e.g., a logistic storage station) and a task destination (e.g., the location of a delivery drop-off). For a newly received pending task (e.g., a second task) having its own associated initial and destined locations, the first phase decision module 232 evaluates the new task location(s) in association with the first mission route. Accordingly, the first phase decision module 232 determines whether the new task location deviates from the originally assigned first mission route, and whether such deviation exceeds an acceptable threshold. If the first phase determination based on position information (dynamically received from a mobile asset) satisfies a predetermined threshold, the first phase decision module 232 may pass the new task information for subsequent processing.

The route planning module 233 can determine one or more feasible routes associated with a logistics task. For instance, based on task information (e.g., departure/destined locations) from the mission information database 224, the route planning module 223 can determine one or more candidate route from an initial location (e.g., the last updated location of an mobile asset upon completion of a first task) to a location associated with an incoming (unscheduled) second task. The route planning may be determined using route searching algorithms based on one or more initial criteria, factors, or variables (e.g., distance, estimated transit time, etc.). Suitable route searching algorithms may include but not limited to, the A* algorithm, best-first algorithms, breadth-first algorithms, depth-first algorithms, Djikstra's algorithm, Munkres algorithm, genetic algorithms, linear programming algorithms, Traveling Salesman algorithms, and combinations or modifications thereof.

For an available/applicable unscheduled task (e.g., newly received second task) that passes the first phase determination (by the first phase decision module 232), the route planning module 223 generates one or more candidate routes based on the location associated with the second task and the mobile asset's last updated location (e.g., the location where the first task was completed). The processing unit 226 then further evaluates the one or more candidate mission routes based on one or more additional parameters of the mobile asset (e.g., an operational parameter in addition to the position information analyzed by the first phase decision module 232, which may also be included in the status message from the mobile terminal 210) to determine an updated mission route for the pending second task.

The learning module 235 may analyze dynamically received or historically recorded data and assist the route planning module 233 in finding optimized mission routes. In some embodiments, the learning module 235 analyzes parameters from the received/recorded data including, but not limited to, user input parameters, traffic condition parameters (e.g., number of traffic stops in a logistics trip, statistical traffic light duration, etc.), vehicle operation parameters (e.g., vehicle load capacity, fuel condition, etc.), driver preference parameter, road condition parameter (e.g., known or forecasted road condition), speed limits, time of day parameters, weather condition parameter, task requirement parameter (e.g., the nature of a task, such as point to point short range delivery or multi-stop long haul delivery), and other predetermined or real-time factors. For instance, the learning module 235 may be provided with capability to determine whether a pending task is suitable for a point-to-point delivery (e.g., using method and system described in U.S. application Ser. No. 15/913,858, filed on Mar. 3, 2018, whose contents is hereby incorporated by reference), and enables the processing unit 226 to further analyze whether such a newly occurred task is suitable to fit into the mission schedule of a particular mobile asset deployed in the field. In some embodiments, data associated with the analysis result of the learning module 235 is fed-back to the mission information database 224 for future reference.

The second phase decision module 234 is configured to receive information regarding the one or more feasible route (e.g., found by the route planning module 233 with help from the learning module 235), and accordingly, perform a second phase determination to evaluate the candidate mission routes based on one or more additional parameters from the onboard terminal of a mobile asset. In the illustrated embodiments, the second phase decision module 234 performs the second tier evaluation based on operational parameter associated with one or more vehicle status information included in the received status message. The vehicle status information may include, but not limited to, vehicle loading capacity, fuel load status, hardware condition status, and operator condition status. The second phase decision based on the dynamic receipt of a mobile asset's operational status may help determining operational feasibility of performing a new task, as well as whether the execution of the subsequently generated mission associated with the unscheduled new task will incur additional operational cost within an economical threshold.

For instance, based on the vehicle's operational parameter (e.g., loading capacity, fuel status, etc.), the second phase decision module 234 may determine whether a mobile asset is capable of taking in the subsequently generated mission associated with the second task. In some embodiments, the second decision module 234 may determines that a mobile asset is capable of carrying out a new mission without returning to a logistics station 228. For example, a mobile asset may have completed a previously assigned first task ahead of schedule with abundant fuel and loading capacity to spare. In such a scenario, the second decision module 234 may deem this mobile asset available for updated duty, and accordingly proceed to subsequent mission generation process (will be discussed further below).

In some embodiments, the second decision module 234 may determines that a mobile asset is capable of carrying out a new mission, but would need to return to the logistics station 228 before taking on the new task. For example, a mobile asset may have completed a previously assigned first task on schedule with marginal fuel and loading capacity to spare, thus is capable of picking up a new shipment back at the station 228 to conduct a new delivery assignment to a location associated with a second task. In such a scenario, the second decision module 234 may determine the projected operational cost (associated with the second task) based on factors including the candidate mission route and the vehicle status information, and analyze whether performing such unplanned task is economically acceptable (e.g., within a predetermined threshold). For instance, if it is determined that the remaining fuel is sufficient for the mobile asset to complete a round trip to the second task location (e.g., within acceptable range of deviation from the mobile asset's original mission route), and such round trip wouldn't incur vehicle operator's overtime, the second decision module 234 may deem this mobile asset available for mission update, but will proceed to a subsequent mission generation process that generates a notification for the mobile asset to return to a logistics station 228 before resuming the second task.

For mission routing plans that are deemed acceptable by the second phase decision module 234, information associated with the originally unscheduled second task is forwarded to the mission generation module 236 for mission generation. In the illustrated embodiment, the mission generation module 236 is data communicatively coupled to the communication module 222, and can dynamically notify the mobile terminal 210 the updated mission routing plan associated with the second task through the communication module 222.

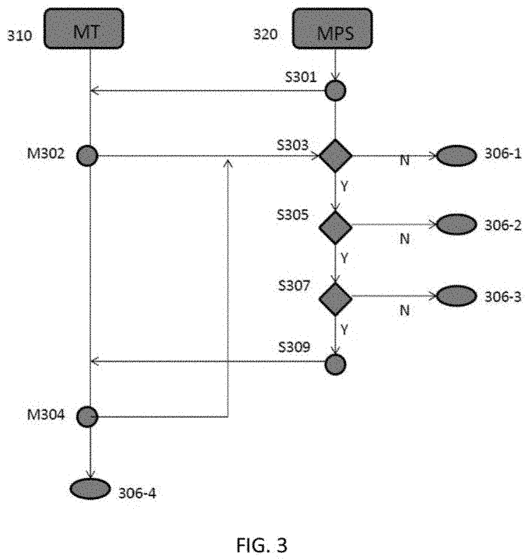

FIG. 3 shows a flow diagram of an illustrative method implementing by a logistics management system in accordance with some embodiments of the instant disclosure.

At process S301, a mission planning server (MPS) 320 communicates to an onboard terminal (MT) 310 of a mobile asset a first mission routing plan associated with a first task. In some embodiments, the first task may be a previously received task (e.g., a delivery task) whose associated information had been stored in a mission information database. The mobile asset then carries out the originally planned logistics duty based on the first routing plan received from the onboard terminal 310.

At process M302, the onboard terminal 310 sends a status message to the MPS 320 upon completion of the originally scheduled first task. The sending of the status message may be triggered either automatically (e.g., upon reaching the scheduled designation, or upon scanning of a bar code scanner) or manually (e.g., by the operator of the mobile asset).

At process S303, the MPS 320 receives the status message from the onboard terminal 310, and performs a new task applicability check. If no available new task (i.e., second task) is found, the MPS 320 may determines that no mission update is applicable, and the process may proceed to termination 306-1. In such a case, the mobile asset may proceed with the remaining portion of the first mission route and return to base station.

Conversely, if a newly documented second task is found available, the MPS 320 may proceed to next analysis process.

At process S305, the MPS 320 performs a first phase analysis. In some embodiments, the first phase decision is based on a mobile asset's position information extracted from the status message. The position information represents the location of the onboard terminal 310 (and the associated mobile asset) upon completion of the first task, which is associated with a first mission route that was previously planned (and at least partially traveled) by the mobile asset. For the newly available second task, the MPS 320 analyzes whether the new task location deviates from the originally assigned first mission route, and whether such deviation exceeds an acceptable threshold. If a range deviation does not satisfy a predetermined threshold (e.g., the second task location deviates too much from the first mission route), the MPS 320 may determine that no mission update is manageable, and the process may proceed to termination 360-2. In such a case, the mobile asset may proceed with the remaining portion of the first mission route and return to base station.

Conversely, if the result of the first phase determination satisfies the predetermined threshold, the process may advance to subsequent analysis process.

At process S307, the MPS 320 performs a second phase analysis. In some embodiments, the second phase decision is based on operational parameter associated with one or more vehicle status information included in the received status message. The vehicle status information may include, but not limited to, vehicle loading capacity, fuel load status, hardware condition status, and operator condition status. The MPS 320 determines the operational feasibility of performing the second task as well as analyzes the associated operational cost. If the mobile asset is deemed operationally incapable, or if execution of the second task will incur additional operational cost exceeding an economical threshold, the MPS 320 may determines that no mission update is feasible, and the process may proceed to termination 306-3. In such a case, the mobile asset may proceed with the remaining portion of the first mission route and return to base station.

Conversely, if the result of the second phase determination satisfies the predetermined threshold, the process may advance to subsequent process.

At process S309, for mission routing plans that are deemed feasible, the MPS 320 notifies the onboard terminal 310 the updated mission routing plan associated with the second task. Upon receipt the updated mission routing plan, the mobile asset may proceed to carry out the logistics duty associated with the second task.

At process M304, the onboard terminal 310 sends another status message to the MPS 320 upon completion of the dynamically generated second task. Upon notification of the completion of the second task, the MPS 320 may iterate the abovementioned processes S303-S309 to determine the applicability of a subsequently available task, or the process may be ended at termination 306-4.

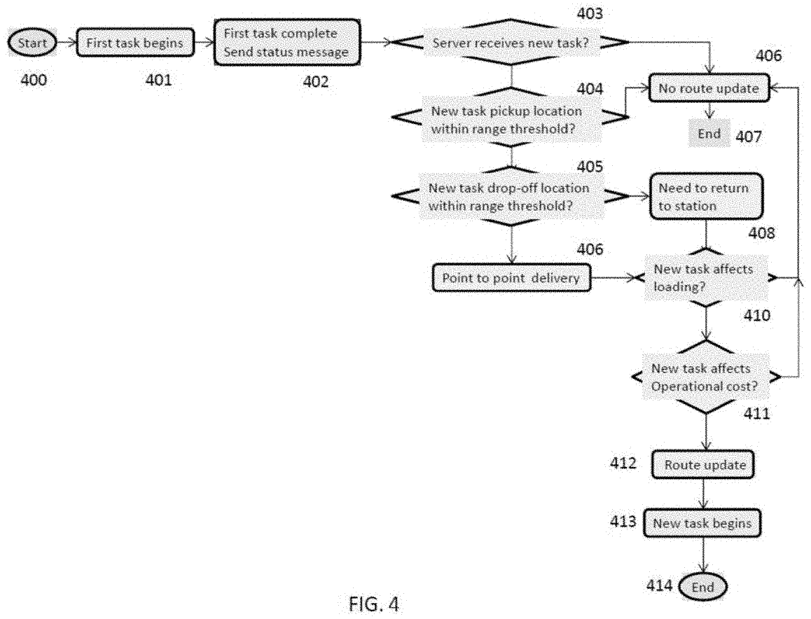

FIG. 4 is a block diagram showing an operation flow of a logistics management method in accordance with some embodiments of the instant disclosure. The method begins at block 400.

At block 401, a mobile asset starts a first logistics task in accordance with an original mission route.

At block 402, the mobile asset completes the first logistics task, and sends a status message to a mission planning server. The status message may contain a position information and operational status information of the mobile asset.

At block 403, the server checks availability of new task. If no new task is available, the method proceeds to block 406, where no mission route is updated. The method then ends at block 407.

If new task is found to be available, the process proceeds to phase one determination at block 404, where an initiation location (e.g., a pickup location) associated with the new task is analyzed with respect to the original mission route. If the initiation location deviates too much from the original mission route, the method proceeds to block 406, where no mission route is updated. The method then ends at block 407.

If the course deviation is within an acceptable threshold, the method proceeds to block 405, where a destination location (e.g., delivery address) associated with the new task is analyzed with respect to the original mission route.

At block 405, if the new task is determined to be a multi-stop long haul delivery, the mobile asset is instructed to return to a logistics station at block 408. On the other hand, If the new task is determined to be a point-to-point delivery at block 409, the method proceeds to phase two determination at block 410.

At block 410, the operational status of the mobile asset is analyzed. If the mobile asset is determined to be capable of performing the new task (e.g., having sufficient fuel load or cargo capacity), the method proceeds to block 411 for further analysis. If the mobile asset is determined to be incapable for further mission, the method proceeds to block 406 without updating mission route. The method then ends at block 407.

At block 411, a cost analysis is performed with respect to a candidate mission plan associated with the new task. If the cost projection is within an acceptable threshold, the method proceeds to block 412, where the mission routing plan for the mobile asset is updated.

At block 413, the mobile asset carries out the new task in accordance with the updated mission routing plan, and the method ends at block 414 when the new task is completed.

The above-described method and operation flow of logistics management may be implemented by computing hardware devices through execution of stored instructions in a non-transitory computer readable medium. The above hardware may include a microprocessor, an application specific integrated circuit, a programmable gate array, a digital processor, an embedded device, or the like. The non-transitory computer readable medium described above may comprise a storage device, such as a magnetic storage medium, an optical disk, a magneto-optical recording medium, a semiconductor memory, or the like.

Accordingly, some embodiment of the instant disclosure provide a logistics management]t system. The logistics management system includes a communication module configured to receive a status message indicating position information of an onboard terminal of a vehicle upon completion of a first task, where the status message further comprises a vehicle status information; a first phase decision module in data communication with the communication module, configured to perform a first phase determination based at least in part on the position information of the status message; a second phase decision module in data communication with the first phase decision module, configured to perform a second phase determination based at least in part on an operational parameter associated with the vehicle status information, and a mission generation module in data communication with the second phase decision module configured to generate a second mission route associate with a second task.

Accordingly, some embodiments of the instant disclosure provide a logistics management method. The method includes: communicating to an onboard terminal of a vehicle from a mission planning server a first mission route associated with a first task; receiving a status message from the onboard terminal upon completion of the first task, wherein the status message comprises position information of the onboard terminal; checking, applicability of a mission candidate associated with a second task; if applicable, performing, by the mission planning server a first phase determination for the applicable mission candidate based on a first threshold; performing, by the mission planning server, a second phase determination based on a second threshold different from the first threshold; and generating, by the mission planning server, a second mission route associated with the second task.

Accordingly, some embodiments of the instant disclosure provide a computer-readable medium in data communication with one or more processors and having instructions stored thereon. Upon execution by the one or more processors, the instructions cause the one or more processors to perform operations that includes: communicating to an onboard terminal of a vehicle a first mission route associated with a first task; receiving a status message from the onboard terminal upon completion of the first task, where the status message comprises position information of the onboard terminal and a vehicle status parameter; checking applicability of a mission candidate associated with a second task; if applicable, performing a first phase determination for applicable mission candidate based on a first threshold; performing a second phase determination based on a second threshold different from the first threshold; and generating a second mission route associated with the second task.

The embodiments shown and described above are only examples. Many details are often found in the art such as the other features of a logistics data management method. Therefore, many such details are neither shown nor described. Even though numerous characteristics and advantages of the present technology have been set forth in the foregoing description, together with details of the structure and function, the disclosure is illustrative only, and changes may be made in the detail, especially in matters of shape, size, and arrangement of the parts within the principles, up to and including the full extent established by the broad general meaning of the terms used in the claims. It will therefore be appreciated that the embodiments described above may be modified within the scope of the claims.

What is claimed is:

1. A logistics management system, comprising:
a communication module configured to receive a status message indicating position information of an onboard terminal of a vehicle upon completion of a first task; the status message further comprising a vehicle status information;
a first phase decision module in data communication with the communication module, configured to perform a first phase determination based at least in part on the position information of the status message;
a second phase decision module in data communication with the first phase decision module, configured to perform a second phase determination based at least in part on an operational parameter associated with the vehicle status information, and
a mission generation module in data communication with the second phase decision module configured to generate a mission route associate with a second task.

2. The system of claim 1, wherein the mission generation module is further configured to:
selectively updating the onboard terminal of the vehicle the second mission route via the communication module.

3. The system of claim 1, wherein the mission generation module is further configured to:
generate a first mission route associate with the first task.

4. The system of claim 1, further comprising:
a mission management database in data communication with the first phase decision module configured to store mission planning information,
wherein the mission management database is configured to check applicability of a mission candidate associated with the second task.

5. A method, comprising:
communicating to an onboard terminal of a vehicle from a mission planning server, a first mission route associated with a first task;
receiving, by the mission planning server, a status message from the onboard terminal upon completion of the first task, wherein the status message comprises position information of the onboard terminal;
checking applicability of a mission candidate associated with a 2^{nd} task; if applicable,
performing, by the mission planning server, a 1^{st} phase determination for applicable mission candidate based on a first threshold;
performing, by the mission planning server, a 2^{nd} phase determination based on a second threshold different from the first threshold; and
generating, by the mission planning server a second mission route associated with the second task.

6. The method of claim 5, further comprising:
selectively updating the onboard terminal of the vehicle from the mission planning server the second mission route.

7. The method of claim 5,
wherein the first threshold corresponds to a geological status parameter.

8. The method of claim 7,
wherein the geological parameter includes a predetermined range of deviation from the first mission route of a location associated with the applicable mission candidate.

9. The method of claim 5,
wherein the performing of the first phase determination further comprises determining whether to notify the onboard terminal to direct the vehicle back to a station.

10. The method of claim 5,
wherein the 2^{nd} mission route is generated for applicable mission candidate that does not exceed the first threshold subsequent to the performing of the 1^{st} phase determination.

11. The method of claim 5,
wherein the status message further comprises a vehicle status parameter

12. The method of claim 11,
wherein the vehicle status parameter includes at least one of loading capacity status, fuel load status, hardware condition status, and operator condition status.

13. The method of claim 11,
wherein the second threshold corresponds to the vehicle status parameter,
wherein the performing of the 2^{nd} phase determination further comprises determining whether a loading parameter associated with the second task exceeds the vehicle status parameter.

14. The method of claim 11,
wherein the second threshold further corresponds in part to vehicle operation cost parameter associated with the second mission route and the vehicle status parameter,
wherein the performing of the second phase determination further comprising determining whether the vehicle operation cost parameter exceed a predetermined value.

15. A computer-readable medium in data communication with one or more processors and having instructions stored thereon which, when executed by the one or more processors, cause the one or more processors to perform operations comprising:
communicating to an onboard terminal of a vehicle a first mission route associated with a first task;
receiving a status message from the onboard terminal upon completion of the first task, wherein the status message comprises position information of the onboard terminal and a vehicle status parameter;
checking applicability of a mission candidate associated with a 2^{nd} task; if applicable,
performing a 1^{st} phase determination for applicable mission candidate based on a first threshold;
performing a second phase determination based on a second threshold different from the first threshold; and
generating a second mission route associated with the second task.

16. The computer readable medium of claim 15, wherein the instruction further causes the processors to perform operations comprising:
selectively updating the onboard terminal of the vehicle the second mission route.

17. The computer readable medium of claim 15,
wherein the first threshold corresponds to a geological status parameter that includes a predetermined range of deviation from the first mission route of a location associated with the applicable mission candidate

18. The computer readable medium of claim 15,
wherein the second threshold corresponds to the vehicle status parameter,
wherein the performing of the second phase determination further comprises determining whether a loading parameter associated with the second task exceeds the vehicle status parameter.

19. The computer readable medium of claim 15,
wherein the second threshold further corresponds in part to vehicle operation cost parameter associated with the second mission route and the vehicle status parameter,
wherein the performing of the second phase determination further comprising determining whether the vehicle operation cost parameter exceed a predetermined value.

20. The computer readable medium of claim 15
wherein the performing of the 1^{st} phase determination further comprises determining whether to notify the onboard terminal to direct the vehicle back to a station.
